(19) United States
(12) Patent Application Publication
(10) Pub. No.: US 2022/0289358 A1
(43) Pub. Date: Sep. 15, 2022

(54) COMPOSITE STRUCTURES FOR AERODYNAMIC COMPONENTS

(71) Applicant: ISRAEL AEROSPACE INDUSTRIES LTD., Lod (IL)

(72) Inventors: Victor WEISSBERG, Holon (IL); Barak MAGEN, Modiin (IL); Elie KOSKAS, Rosh Haayin (IL)

(21) Appl. No.: 17/635,874

(22) PCT Filed: Aug. 20, 2020
(86) PCT No.: PCT/IL2020/050915

§ 371 Date: Feb. 16, 2022

(30) Foreign Application Priority Data
Aug. 22, 2019 (IL) 268846

(51) Int. Cl. B64C 1/00; B64C 1/26; B64C 3/14; B64C 1/22

(52) U.S. Cl. CPC B64C 1/0009; B64C 1/26; B64C 3/14; B64C 1/22; B64C 2001/0072

(57) ABSTRACT

There is provided a composite structure for an aerodynamic component having an aerofoil-like cross-section and a leading edge, the composite structure being in the form of a torsion box arrangement made from composite materials and having a core, the torsion box having a forward wall, an aft wall, a top wall and a bottom wall, together defining the core, the front wall being formed as the leading edge of the aerodynamic component. Also provided is a load-bearing composite structure for use with an aerodynamic component and configured for supporting at least one external load, this composite structure being made from composite materials and configured for being joined to the external aerodynamic surface of the aerodynamic component such as to be in overlying abutting relationship with at least a contact surface portion of the external aerodynamic surface, including the leading edge, at least a forward portion of each of the suction surface and the pressure surface thereof.

### TECHNOLOGICAL FIELD

The presently disclosed subject matter relates to composite structures, in particular for aerodynamic components or for use with aerodynamic components.

### BACKGROUND

It is known to manufacture wings and similar aerodynamic components from non-metallic composite materials. In some cases, the mechanical structure of the composite wing includes a torsion box having two axially spaced spars interconnected via two spaced skins, the two spars being spaced aft from the leading edge of the aerodynamic component.

It is also known to carry external stores on wings made from composite materials. Conventionally, pylon-type structures are used for such purposes, having similar design features as in metallic wings. Such pylons are conventionally mounted to the underside of the composite material wings and in load-bearing contact with the composite wing main spar, which conventionally carries the majority weight of the loads from the external stores.

### GENERAL DESCRIPTION

According to a first aspect of the presently disclosed subject matter there is provided a composite structure for an aerodynamic component having an aerofoil-like cross-section (also referred to herein as an “aerofoil”) and a leading edge, the composite structure being in the form of a torsion box arrangement having a core, the torsion box arrangement being made from composite materials, wherein the torsion box has a forward wall, an aft wall, a top wall and a bottom wall, together defining said core, and wherein said front wall is formed as the leading edge of the aerodynamic component.

Thus, according to this aspect of the presently disclosed subject matter there is provided a composite structure for an aerodynamic component having an aerofoil-like cross-section and a leading edge, the composite structure being in the form of a torsion box arrangement made from composite materials and having a core, the torsion box having a forward wall, an aft wall, a top wall and a bottom wall, together defining the core, the front wall being formed as the leading edge of the aerodynamic component.

In other words the front wall does not have the shape of a spar or of the web of a spar, i.e., the front wall is non-planar and does not have a flat shape, but is rather in a shape of a “C” following the contour of the leading edge of the aerodynamic component.

By leading edge is meant the actual leading edge of the aerodynamic component in examples where the leading edge is fixed with respect to the aerofoil, or, in aerofoils in which include a movable slat leading edge is meant the leading edge of the aerodynamic component excluding the slat.

For example, said top wall is formed with an external first surface corresponding to a suction surface of the aerodynamic component, and wherein said bottom wall is formed with an external second surface corresponding to a pressure surface of the aerodynamic component. Optionally for example:
said forward wall is longitudinally spaced from said aft wall by a longitudinal spacing; and/or
said upper wall is transversely spaced from said bottom wall by a transverse spacing; and/or
the forward wall is connected to a respective first edge of each one of said top wall and said bottom wall; and/or
the aft wall is connected to a respective second edge of each one of said top wall and said bottom wall; and/or
said forward wall and said aft wall have a transverse dimension whereby to provide said transverse spacing; and/or
said top wall and said bottom wall have a longitudinal dimension whereby to provide said longitudinal spacing.

Additionally or alternatively, for example, said forward wall comprises an externally facing aerodynamic leading edge surface and an internally facing leading end inner surface.

Additionally or alternatively, for example:
said top wall comprises an externally facing first aerodynamic surface and an internally facing first inner surface;
said bottom wall comprises an externally facing second aerodynamic surface and an internally facing second inner surface;

Additionally or alternatively, for example, said aft wall is configured structurally as a trailing end spar and includes an externally facing trailing end surface and an internally facing leading end inner surface. For example:
said forward wall, said aft wall, said top wall, and said bottom wall are made from composite materials; and
wherein said internally facing leading end inner surface, said internally facing first inner surface, said internally facing second inner surface, and said internally facing leading end inner surface enclose said core.

Additionally or alternatively, for example, said torsion box arrangement extends laterally between a first torsion box end and a second torsion box end. For example, said torsion box arrangement has a lateral dimension between a first torsion box end and a second torsion box end.

Additionally or alternatively, for example, said torsion box arrangement has an absence of any structural member, different from said aft wall, transversely spanning said hollow core between said top wall and said bottom wall.

Additionally or alternatively, for example, said core is spar-less.

Additionally or alternatively, for example, said torsion box arrangement has an absence of any structural member, different from said aft wall, accommodated in said core and extending in a spanwise direction.

Additionally or alternatively, for example, the torsion box arrangement, has an absence of a main spar, or of a web of such a main spar, at the respective conventional location of such a main spar in conventional wings.

Additionally or alternatively, for example, the torsion box arrangement, has an absence of a main spar, or of a web of such a main spar, at least between the aerofoil leading edge and 60% of a chord of the aerofoil, or at least between the aerofoil leading edge and 50% of the chord of the aerofoil, or at least between the aerofoil leading edge and 40% of the chord of the aerofoil, or at least between the aerofoil leading edge and 30% of the chord of the aerofoil, or at least between 20% and 30% of the chord of the aerofoil aft of the aerofoil leading edge.

Additionally or alternatively, for example, said core is rib-less.

Additionally or alternatively, for example, said torsion box arrangement has an absence of any rib structural member, accommodated in said core between said top wall and said bottom wall.

Additionally or alternatively, for example, said top wall and said bottom wall each extends aft in a chordwise direction at least past a chordwise location of the neutral point NP of the aerofoil.

Additionally or alternatively, for example, said top wall and said bottom wall each extends aft in a chordwise direction at least past between 20% and 30% of a chord of the aerofoil. For example, said top wall and said bottom wall each extends aft in a chordwise direction more than 40%, or more than 50% or more than 60% or more than 70% of the chord.

Additionally or alternatively, for example, said forward wall is configured structurally as a leading end spar.

Additionally or alternatively, for example, said forward wall, said aft wall, said top wall, and said bottom wall are made exclusively from a first composite material.

Additionally or alternatively, for example, said forward wall, said aft wall, said top wall, and said bottom wall are made from a first composite material comprising multiple layers of composite fibers embedded in a matrix, and further comprising a second composite material comprising a stiffening structure.

Additionally or alternatively, for example, wherein said forward wall, said aft wall, said top wall, and said bottom wall have an absence of metallic materials.

Additionally or alternatively, for example, said torsion box arrangement has a closed transverse section.

Additionally or alternatively, for example, said core is a hollow core.

Additionally or alternatively, for example, said core is at least partially fillable with a liquid material.

Additionally or alternatively, for example, said top wall comprises at least one first stiffening member co-extensive therewith (along a direction parallel to the span axis of the aerodynamic member) and joined thereto. For example, said at least one first stiffening member is made from third composite materials comprising a unidirectional fiber structure embedded in a matrix.

Additionally or alternatively, for example, said bottom wall comprises at least one second stiffening member co-extensive therewith (along a direction parallel to the span axis of the aerodynamic member) and joined thereto. For example, said at least one second stiffening member is made from fourth composite materials comprising a unidirectional fiber structure embedded in a matrix.

Additionally or alternatively, for example, said externally facing aerodynamic leading edge surface, said first externally facing first aerodynamic surface, said externally facing second aerodynamic surface and said externally facing trailing end surface define an outer mold line.

Additionally or alternatively, for example, said internally facing leading end inner surface, said internally facing first inner surface, said internally facing second inner surface, and said internally facing leading end inner surface define an inner mold line.

Additionally or alternatively, for example, the aerodynamic component is a wing, and wherein said forward wall is configured aerodynamically as a leading edge of the wing

Additionally or alternatively, for example, the aerodynamic component is any one of: a vertical stabilizer, horizontal stabilizer, vane, canard, rudder, other aerodynamic control surfaces.

Additionally or alternatively, for example, the composite structure according to the aspect of the presently disclosed subject matter further comprises a load-bearing composite structure for use with the aerodynamic component, according to a second aspect of the presently disclosed subject matter. For example, the aerodynamic component has an external aerodynamic surface including said leading edge and a trailing edge, said suction surface extending between the leading edge and the trailing edge, and said pressure surface extending between the leading edge and the trailing edge, the load bearing composite structure being made from composite materials and configured for being joined to the external aerodynamic surface such as to be in overlying abutting relationship with at least a contact surface portion of the external aerodynamic surface, the contact surface portion including the leading edge, at least a forward portion of the suction surface and at least a forward portion of the pressure surface of the external aerodynamic surface, the load-bearing composite structure being further configured for supporting at least one external load.

For example, the load-bearing composite structure comprises a wing-coupling portion configured for coupling to the aerodynamic component, and an external load coupling portion configured for coupling to said at least one external load. For example, said wing-coupling portion is configured for being joined or otherwise connected to the external aerodynamic surface such as to be in overlying abutting and load bearing relationship with at least said contact surface portion.

Additionally or alternatively, for example, said wing-coupling portion comprises a functional surface conforming to the contact surface portion of the external aerodynamic surface.

Additionally or alternatively, for example, said external load coupling portion comprises a pair of spaced lateral walls for holding therein at least a part of said at least one external load, and further comprising at least one peg configured for concurrently traversing said pair of spaced lateral walls and said part of said at least one external load.

Additionally or alternatively, for example, said external load is in the form of any one of:
a boom connected to an empennage;
an external store having a pylon structure;
an external store having a pylon structure, wherein said external stores includes any one of: engine, a fuel tank, a camera, weapons.

According to the second aspect of the presently disclosed subject matter there is provided a load-bearing composite structure for use with an aerodynamic component, the aerodynamic component having an external aerodynamic surface including a leading edge and a trailing edge, a suction surface extending between the leading edge and the trailing edge, and a pressure surface extending between the leading edge and the trailing edge, the composite structure being made from composite materials and configured for being joined to the external aerodynamic surface such as to be in overlying abutting relationship with at least a contact surface portion of the external aerodynamic surface, the contact surface portion including the leading edge, at least a forward portion of the suction surface and at least a forward portion of the pressure surface of the external aerodynamic surface, the load-bearing composite structure being further configured for supporting at least one external load.

Thus according to this aspect of the presently disclosed subject matter there is provided a load-bearing composite structure for use with an aerodynamic component and configured for supporting at least one external load, this composite structure being made from composite materials and configured for being joined to the external aerodynamic surface of the aerodynamic component such as to be in overlying abutting relationship with at least a contact surface portion of the external aerodynamic surface, including the leading edge, at least a forward portion of each of the suction surface and the pressure surface thereof.

For example, the load-bearing composite structure comprises a wing-coupling portion configured for coupling to the aerodynamic component, and an external load coupling portion configured for coupling to said at least one external load. For example, said wing-coupling portion is configured for being joined or otherwise connected to the external aerodynamic surface such as to be in overlying abutting and load bearing relationship with at least said contact surface portion.

Additionally or alternatively, for example, said wing-coupling portion comprises a functional surface conforming to the contact surface portion of the external aerodynamic surface.

Additionally or alternatively, for example, said external load coupling portion comprises a pair of spaced lateral walls for holding therein at least a part of said at least one external load. For example, the load-bearing composite structure comprises at least one peg configured for concurrently traversing said pair of spaced lateral walls and said part of said at least one external load.

Additionally or alternatively, for example, said external load is in the form of a boom connected to an empennage.

Additionally or alternatively, for example, said external load is in the form of an external store having a pylon structure. For example, said external stores includes any one of: engine, a fuel tank, a camera, weapons.

Additionally or alternatively, for example, the aerodynamic component is a wing.

A feature of at least one example according to the first aspect of the presently disclosed subject matter is that there is provided a composite structure for an aerodynamic component having an aerofoil-like cross-section, which can be lighter in weight and/or less expensive to manufacture, than a similar composite structure made in a conventional manner having a main spar.

Another feature of at least one example according to the first aspect of the presently disclosed subject matter is that there is provided a composite structure for an aerodynamic component having an aerofoil-like cross-section, which requires less component parts for the manufacture thereof, than a similar composite structure made in a conventional manner having a main spar.

Another feature of at least one example according to the first aspect of the presently disclosed subject matter is that there is provided a composite structure for an aerodynamic component having an aerofoil-like cross-section, and which can be used as a so-called “wet wing” for fuel storage, wherein there is additional volume available for fuel storage as compared to a similar conventional wing in which such fuel storage is typically between the front and rear spars of the conventional torsion box of the wing.

A feature of at least one example according to the second aspect of the presently disclosed subject matter is that a so-called external rib is provided that replaces the need for as conventional pylon, allowing the addition of payload at any span-wise location on the wing, even after the wing manufactured.

Another feature of at least one example according to the second aspect of the presently disclosed subject matter is that a so-called external rib is provided can be removed from the wing when not in use or when desired, since the wing is designed structurally in the absence of such an external rib.

### BRIEF DESCRIPTION OF THE DRAWINGS

In order to better understand the subject matter that is disclosed herein and to exemplify how it may be carried out in practice, examples will now be described, by way of non-limiting example only, with reference to the accompanying drawings, in which:

FIG. 1 is a side view of a first example of a composite structure for an aerodynamic component, according to a first aspect of the presently disclosed subject matter.

FIG. 2 is a plan view of the example of FIG. 1.

FIG. 3 is a transverse cross-section of the example of FIG. 1, schematically illustrating an example of the manufacturing construction thereof.

FIG. 4 is a cross-sectional and partially cut-out side view of a first example of a composite structure for an aerodynamic component, according to a second aspect of the presently disclosed subject matter; FIG. 4(a) is a cross-sectional view of the example of FIG. 4 taken along section A-A; FIG. 4(b) is a cross-sectional view of the example of FIG. 4 taken along section B-B; FIG. 4(c) is a cross-sectional view of the example of FIG. 4 taken along section C-C.

FIG. 5 is a cross-sectional and partially cut-out side view of an alternative variation of the first example of FIGS. 4, 4(a), 4(b), 4(c); FIG. 5(a) is a cross-sectional view of the example of FIG. 5 taken along section A-A; FIG. 5(b) is a cross-sectional view of the example of FIG. 5 taken along section B-B; FIG. 5(c) is a cross-sectional view of the example of FIG. 5 taken along section C-C.

FIG. 6 is a cross-sectional side view of another alternative variation of the first example of FIGS. 4, 4(a), 4(b), 4(c); FIG. 6(a) is a cross-sectional view of the example of FIG. 6 taken along section A-A; FIG. 6(b) is a cross-sectional view of the example of FIG. 6 taken along section B-B.

### DETAILED DESCRIPTION

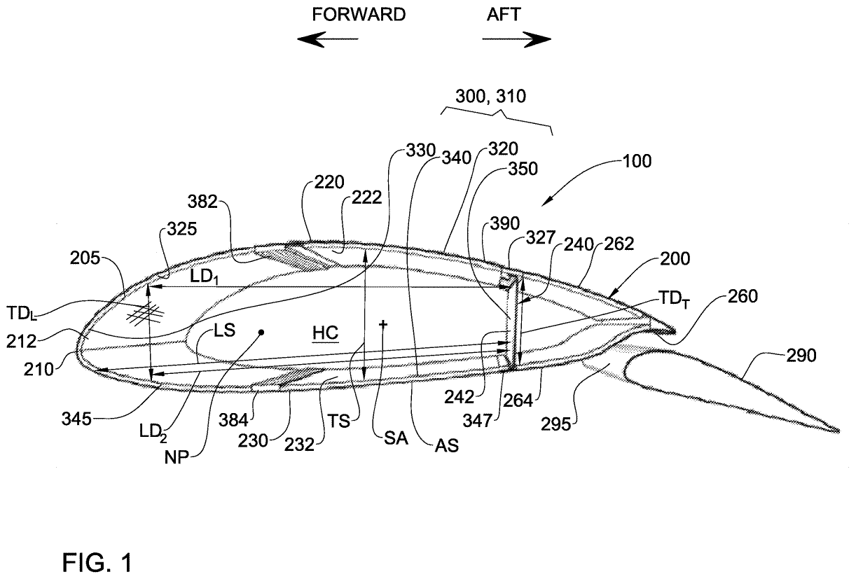

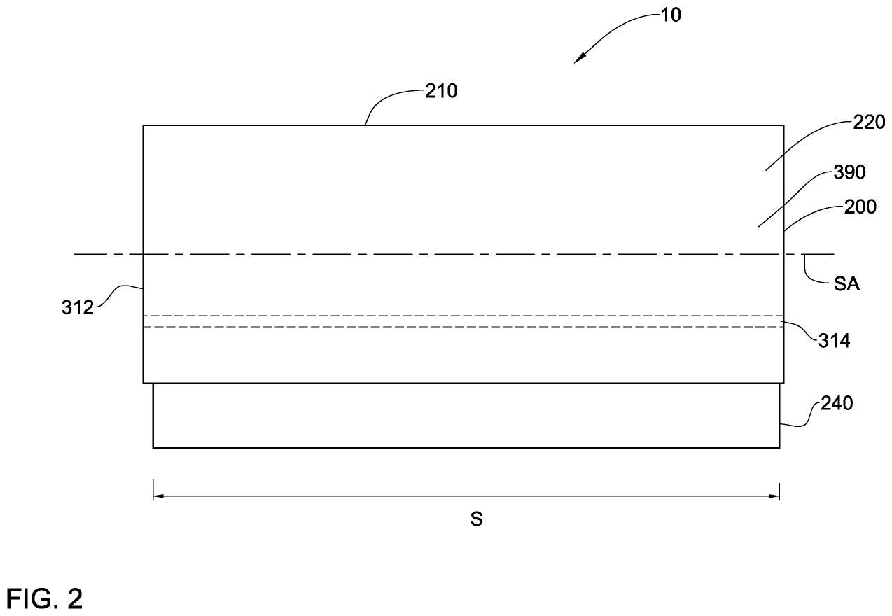

Referring to FIGS. 1 and 2, a composite structure according to a first example of a first aspect of the presently disclosed subject matter, generally designated 100, is in the form of a load-bearing external skin 300 having an outer skin surface 390, and is provided for an aerodynamic component 200. In other words, the aerodynamic component 200 has a structure corresponding to the composite structure 100.

The aerodynamic component 200 is configured for aerodynamically interacting with an airflow and has an aerofoil-like cross section. By “aerofoil-like cross-section” is meant that the aerodynamic component 200 has a cross-section shaped as at least the front end of an aerofoil section AS, having at least an external aerodynamic surface 205 including an externally facing aerofoil leading edge 210, an externally facing first aerodynamic surface 220, an externally facing second aerodynamic surface 230 generally co-extensive with and spaced from the first aerodynamic surface 220, and a trailing end surface 240. In at least this example, the aerofoil leading edge 210 has a leading edge radius, having a non-zero dimension.

In the illustrated example, the aerodynamic component 200 is at least a part of a subsonic or transonic wing 10, for generating aerodynamic lift for an aircraft, in which in at least some examples the wing can be connected to an aircraft fuselage. The wing has a span axis SA generally orthogonal to the aerofoil-like cross sections. However, in variations of this example and in other examples, the aerodynamic component 200 can instead be any one of: vane, rudder, aileron, flap, horizontal stabilizer, canard, and so on.

Thus, in the illustrated example, the first aerodynamic surface 220 corresponds to a suction surface of the aerofoil and extends aft from the aerofoil leading edge 210, and the second aerodynamic surface 230 corresponds to a pressure surface of the aerofoil and also extends aft from the aerofoil leading edge 210. The first aerodynamic surface 220 is transversely spaced from the second aerodynamic surface 230 by the thickness of the aerofoil, which can vary along the chord of the aerofoil.

In this example, the trailing end surface 240 is joined to an aft fairing 260 configured for being in spaced relationship with respect to an actuable control surface 290, for example an aileron or flap, via gap 295. In alternative variations of this examples, and in other examples, the aft fairing 260 is instead configured as a trailing edge of the wing, and thus the cross-section of the aerodynamic component 200 includes the corresponding full aerofoil including the trailing edge of the aerofoil.

According to the first aspect of the presently disclosed subject matter, the composite structure 100 has a monocoque construction, in which the external skin 300 carries all or a major part of the stresses of the wing 10. In particular, the composite structure 100 is in the form of a torsion box arrangement 310 having a core HC, which in this example is a hollow core that optionally can be partially filled or fully filled with liquid fuel. In other words, the external skin 300 has a form corresponding to the aforesaid torsion box arrangement 310 to provide the monocoque construction.

By “torsion box arrangement” is meant having a general arrangement of a torsion box, having a general construction including layers (or skins) surrounding a core (which for example can be a hollow core that stays hollow, or for example for example can be an initially hollow core that can be reversibly filled—partially or fully—with a material, for example liquid fuel) in a closed polygonal manner around the core, and designed to resist torsion under an applied load, typically aerodynamic loads, and the torsion box structure typically uses the properties of the relatively thin skins to carry the loads.

The composite structure 100, in particular the torsion box arrangement 310, and more in particular the skin 300 comprises a leading end wall 330 (also referred to interchangeably herein as a forward wall), a trailing end wall 350 (also referred to interchangeably herein as an aft wall), a first outer wall 320 (also referred to interchangeably herein as a top wall), and a second outer wall 340 (also referred to interchangeably herein as a bottom wall).

The leading end wall 330 is longitudinally spaced from the trailing end wall 350 by a longitudinal spacing LS.

The first outer wall 320 is transversely spaced from the second outer wall 340 by a transverse spacing TS.

The leading end wall 330 is connected or otherwise joined to a first end 325 of the first outer wall 320 and to a first end 345 of the second outer wall 340.

The trailing end wall 350 is connected or otherwise joined to a second end 327 of the first outer wall 320 and to a second end 347 of the second outer wall 340.

The leading end wall 330 and said trailing end wall 350 have respective transverse dimensions TD_{L} and TD_{T} whereby to provide the transverse spacing TS; the first outer wall 320 and the second outer wall 340 have respective longitudinal dimensions LD₁ and LD₂ whereby to provide the longitudinal spacing LS.

It is to be noted that both the externally facing first aerodynamic surface 220, and the externally facing second aerodynamic surface 230 (and thus top wall 320 and bottom wall 340) extend aft in a chordwise direction at least well past the chordwise location of the neutral point NP of the aerofoil, which is typically between 20% and 30% of the chord. For example, both the externally facing first aerodynamic surface 220, and the externally facing second aerodynamic surface 230 extend aft in a chordwise direction to (and thus the trailing end surface 240 is located at) more than 40%, or more than 50% or more than 60% or more than 70% of the chord.

The leading end wall 330 is configured aerodynamically as an aerofoil leading edge, comprising or defining the externally facing aerodynamic leading edge surface 210, and further comprises an internally facing leading end inner surface 212. It is to be noted that at least in this example, the leading end wall 330 is generally C-shaped in cross-section, corresponding to the leading edge of the aerofoil type cross-section of the wing 10, and that the internally facing first inner surface 212 is also generally C-shaped in cross-section.

The first outer wall 320 comprises or defines the externally facing first aerodynamic surface 220, and further comprises an internally facing first inner surface 222.

The second outer wall 340 comprises or defines the externally facing second aerodynamic surface 230, and further comprises an internally facing second inner surface 232.

The trailing end wall 350 is configured structurally as a trailing end spar and includes or defines the externally facing trailing end surface 240, and further comprises an internally facing leading end inner surface 242. According to the first aspect of the presently disclosed subject matter the trailing end wall 350 does not resist any or even a majority of the bending loads of the wing 10, and can be considered to act essentially as a continuation of the load-bearing external skin 300 to geometrically “close” the aft end of the torsion box arrangement 310.

The skin 300, and thus the torsion box arrangement 310, comprises the leading end wall 330, the trailing end wall 350, the first outer wall 320, and the second outer wall 340, joined or connected serially to one another to form a closed body in planes normal to the span direction SD of the wing 10.

According to the aforesaid first aspect of the presently disclosed subject matter, the skin 300, and in particular the leading end wall 330, the trailing end wall 350, the first outer wall 320, and the second outer wall 340, are made from composite materials, in particular non-metallic materials, as will become clearer herein.

Furthermore, according to aforesaid first aspect of the presently disclosed subject matter, the skin 300 encloses the hollow core HC, which at least in some examples can be used as an internal fuel tank or a wing fuel tank for containing liquid fuel. In particular, the internally facing leading end inner surface 212, the internally facing first inner surface 222, the internally facing second inner surface 232, and the internally facing trailing end inner surface 242 enclose, face and define the hollow core HC.

It is to be noted that the internally facing leading end inner surface 212, the internally facing first inner surface 222, the internally facing second inner surface 232, and the internally facing trailing end inner surface 242 are contiguous to thereby define a skin inner surface 380.

Inner skin surface 380 thus defines and fully encloses the hollow core HC.

According to the aforesaid first aspect of the presently disclosed subject matter, the torsion box arrangement 310 extends laterally, i.e. along span axis SA, between a first torsion box end 312 and a second torsion box end 314. For example the first torsion box end 312 can be close to or include the wing tip of wing 10, and/or the second torsion box end 314 can be close to or include the wing root of the wing 10. Thus, torsion box arrangement 310 has a lateral dimension between a first torsion box end 312 and a second torsion box end 314, corresponding to the full span S or to part of the span S of the wing 10.

It is to be noted that, according to the aforesaid first aspect of the presently disclosed subject matter, the composite structure 100, in particular the torsion box arrangement 310, and more in particular the skin 300, has an absence of any structural member, different from trailing end wall 350, transversely spanning said hollow core HC between the first outer wall 320 and the second outer wall 340, or otherwise accommodated in the hollow core and extending in a spanwise direction, i.e., along the span axis SA. For example, the hollow core HC is spar-less, i.e., there are no spars within the hollow core HC. In particular, the composite structure 100, in particular the torsion box arrangement 310, and more in particular the skin 300, has an absence of a main spar, or of a web of such a main spar, at the respective conventional location of such a main spar in conventional wings, i.e., at least between the aerofoil leading edge 210 and 60% of the chord of the aerofoil, more particularly at least between the aerofoil leading edge 210 and 50% of the chord of the aerofoil, more particularly at least between the aerofoil leading edge 210 and 40% of the chord of the aerofoil, more particularly at least between the aerofoil leading edge 210 and 30% of the chord of the aerofoil, more particularly at least between 20% and 30% of the chord of the aerofoil aft of the aerofoil leading edge 210.

Similarly, according to the aforesaid first aspect of the presently disclosed subject matter, the hollow core HC is rib-less, i.e., there are no internal ribs within the hollow core HC, and thus the torsion box arrangement has an absence of any rib structural member, accommodated within the hollow core HC between the first outer wall 320 and the second outer wall 340.

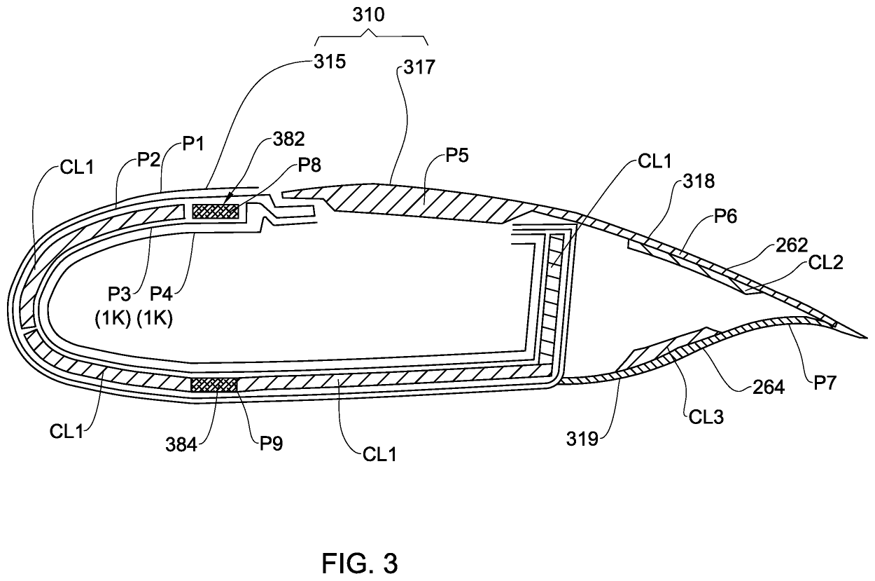

Referring also to FIG. 3, the torsion box arrangement 310 of this example can be provided in two parts that are manufactured separately and then joined together, for example comprising a first body part 315 and a second body part 317.

In the example, of FIG. 3, the first body part 315 includes the leading end wall 330, second outer wall 340, trailing end wall 350, and a forward part of the first outer wall 320. The second body part 317 includes the aft part of the first outer wall 320, and is affixed to the first body part 315 to form the closed monocoque construction of the torsion box arrangement 310. It is to be noted that optionally, and in the illustrated example of FIG. 3, the second body part 317 also includes an aft-projecting wall corresponding to an upper fairing portion 262 of fairing 260, and a lower fairing portion 264 of fairing 260 can be connected to the upper fairing portion 262 and to an aft portion of the main body part 315.

In the illustrated example of FIGS. 1 to 3, the composite structure 100, in particular the torsion box arrangement 310, further comprises a first stiffening member 382 and a second stiffening member 384, both running nominally parallel to the span axis SA. In at least this example the first stiffening member 382 is affixed to or embedded in the first outer wall 320, and the second stiffening member 384 is affixed to or embedded in the second outer wall 340. The first stiffening member 382, and the second stiffening member 384 are configured for providing further stiffness to the composite structure 100 in a direction nominally parallel to the span axis SA.

In at least this example the first stiffening member 382 and the second stiffening member 384 are located at the same chordwise location, and thus can be considered to be similar in function to the flanges of a web-less fictitious I-beam.

For example, the first stiffening member 382 and the second stiffening member 384 are each located chordwise direction at or in the vicinity of the neutral point NP of the aerofoil. for example, the first stiffening member 382 and the second stiffening member 384 are each located chordwise direction at least between the aerofoil leading edge 210 and 60% of the chord of the aerofoil, more particularly at least between the aerofoil leading edge 210 and 50% of the chord of the aerofoil, more particularly at least between the aerofoil leading edge 210 and 40% of the chord of the aerofoil, more particularly at least between the aerofoil leading edge 210 and 30% of the chord of the aerofoil, more particularly at least between 20% and 30% of the chord of the aerofoil aft of the aerofoil leading edge 210.

Furthermore, for example, the first stiffening member 382 and the second stiffening member 384 each have a polygonal cross-section, for example a quadrilateral cross-section, for example a rectangular cross-section. However in alternative variations of this example and in other examples, first stiffening member 382 and the second stiffening member 384 are located at different chordwise locations—for example the first stiffening member 382 can be forward of the second stiffening member 384, or, the first stiffening member 382 can be aft of the second stiffening member 384.

In at least this example the first stiffening member 382 is made from a suitable first composite, and non-metallic, material, and the second stiffening member 384 is made from a suitable second composite, and non-metallic, material, as will become clearer herein. While in at least this example, the first composite material and the second composite material are the same material, in alternative variations of this example, the first composite material and the second composite material are different materials one to the other.

In at least this example, for example, the first stiffening member 382 and the second stiffening member 384 are each made from anisotropic composite materials. For example, the first stiffening member 382 and/or the second stiffening member 384 can include a plurality of layers P8, P9, respectively, overlaid over one another. For example, each one of layer P8 and layer P9 can include a plurality, for example four overlaid plies, in which each plie comprises a respective plurality of unidirectional fibers embedded in a matrix, the unidirectional fibers being in general parallel relationship to the span axis SA.

Referring also to FIG. 3, the illustrated example of the torsion box arrangement 310, in particular each one of the first body part 315 and the second part 317, comprises a multi-layered structure, in particular a sandwich structure, having one or more outer layers on either side of a lightweight core.

For example, the main body part 315 comprises an innermost layer P4 that defines a corresponding part of the skin inner surface 380. One or more additional inner intermediate layers P3 are overlaid over innermost layer P4. A first core layer CL1 is overlaid over layer P3, and the first stiffening member 382 and the second stiffening member 384 are also overlaid over layer P3 at locations in which the thickener layer is modified to accommodate the stiffening members. One or more outer intermediate layers P2 are overlaid over the first core layer CL1, and a final uppermost later P1 is overlaid over the layer P2.

The second body part 317 can be made from a plurality of layers P5 overlaid over one another. The second body part 317 can also be made integrally or joined with a first aft portion 318 corresponding to the upper fairing portion 262 of fairing 260.

The first aft portion 318 can include a plurality of layers P6 overlaid over one another, and overlying a second core layer CL2.

The body part 315 can also be made integrally or joined with a second aft portion 319 corresponding to the lower fairing portion 264 of fairing 260.

The second aft portion 319 can include a plurality of layers P7 overlaid over one another, and overlying a third core layer CL3.

Once formed, the first body part 315 can be joined to the second body part 317, for example via any suitable adhesive. Furthermore, the second aft portion 319 can be joined to the first aft portion 319 to form fairing 260.

Each of the layers P1, P2, P3, P4, P5, P6, P7 can be similar to one another or different from one another.

In at least this example, each of the layers P1, P2, P3, P4, P5, P6 is bidirectional or isotropic.

For example, each one of the layers P1, P2, P3, P4 comprises a respective first plurality of first fibers and a second plurality of second fibers embedded in a matrix, the second fibers being in a non-parallel orientation (in this example, in orthogonal orientation) with respect to the first fibers. In this example, the first fibers are oriented at +45° to the span direction SA, and the second fibers are oriented at −45° to the span direction SA. In alternative variations of this example, the first fibers are oriented at +40° to the span direction SA, and the second fibers are oriented at −50° to the span direction SA. In other alternative variations of this example, the first fibers are oriented at +30° to the span direction SA, and the second fibers are oriented at −60° to the span direction SA.

For example, layer P5 can include a plurality, for example four overlaid plies, in which each plie comprises a respective third plurality of third fibers and a fourth plurality of fourth fibers embedded in a matrix, the fourth fibers being in a non-parallel orientation (in this example, in orthogonal orientation) with respect to the third fibers.

For example, one of layer P6 or layer P7 can include a plurality, for example two overlaid plies, in which each plie comprises a respective fifth plurality of fifth fibers and a sixth plurality of sixth fibers embedded in a matrix, the sixth fibers being in a non-parallel orientation (in this example, in orthogonal orientation) with respect to the fifth fibers.

For example, each such matrix referred to above can be a curable material, and can be or can include one or more of the following, for example: epoxy resin, or any other suitable resinous matrix, thermoplastic resin or other thermosetting resin, or polyester resins, or vinyl ester resins, or phenolic resins, or polyimides, or polybenzimidazoles (PBI), or bismaleimides (BMI), or semicrystalline thermoplastics, or amorphous thermoplastics, or polyether ether ketones.

For example, the respective first fibers and/or the respective second fibers and/or the respective third fibers and/or the respective fourth fibers and/or the respective fifth fibers and/or the respective sixth fibers and/or unidirectional fibers can be or can include one or more of the following fibers: carbon/graphite fibers, or fiberglass fibers, or Kevlar fibers, or boron fibers, or ceramic fibers.

For example, the first core layer CL1 and/or the second core layer CL2 and/or the third core layer CL3 can be in the form of a honeycomb construction, for example anisotropic honeycomb construction.

For example, each such honeycomb construction can be made from or can include one or more of the following materials, for example: aramid paper, fiberglass, Kraft paper, thermoplastics, aluminium, steel, titanium, carbon, ceramics.

For example, each such honeycomb construction can have a regular hexagonal honeycomb structure, or a flexicore structure, or a bisected honeycomb structure, or an overexpanded structure.

Alternatively, the first core layer CL1 and/or the second core layer CL2 and/or the third core layer CL3 can be in the form of a foam construction, and can be made from or can include one or more of the following materials, for example: polystyrene (Styrofoam), phenolic, polyurethane, polypropylene, polyvinyl chloride (PVC), polymethacrylimide (Rohacell).

Alternatively, the first core layer CL1 and/or the second core layer CL2 and/or the third core layer CL3 can be made from balsa wood.

For example, the overlaying process of the layers can be carried out with a mandrel or in a mold, as is known in the art.

It is to be noted that at least in the illustrated example of the torsion box arrangement 310, in particular each one of the first body part 315 and the second part 317, such a torsion box arrangement 310 is provided having sufficient mechanical properties to meet, in conjunction with the first stiffening member 382 and the second stiffening member 384, the design bending moment requirement for the aerodynamic component 200. For example, the stiffness and/or thickness of the skin corresponding to the torsion box arrangement 310, in particular each one of the first body part 315 and the second part 317, is greater than would otherwise be if the torsion box arrangement 310 were to include a main spar in the conventional manner. Parameters that can be adjusted to provide such mechanical properties can for example include one or more of the following: sizing of aerofoil, the skin thickness, the profiling, expected bending loads, the locations of the first stiffening member 382 and the second stiffening member 384. Such parameters can be chosen to avoid risk of skin buckling for the torsion box arrangement 310 at the design bending moment and/or at other desired conditions.

Without being bound to theory, the inventors consider that the torsion box construction according to the first aspect of the presently disclosed subject matter, in which the forward wall of the torsion box is formed as the aerodynamic leading edge of the aerodynamic component (i.e., in the shape of the aforesaid aerodynamic leading edge, and not as a relatively flat wall) and optionally includes part of the first outer wall and/or part of the second outer wall of the aerodynamic component, provides the necessary stiffness to the wing 10, without the need for and thus excluding a forward main spar, or ribs. In at least some examples this is accomplished by providing the first stiffening member 382 and the second stiffening member 384 in place of the flanges of a conventional main spar, in which the first stiffening member 382 and the second stiffening member 384 are made from composite (non-metallic) materials having unidirectional fibers running along the span direction SA, and in which the function of web of such a conventional main spar is instead accomplished by the skin of the torsion box arrangement 310.

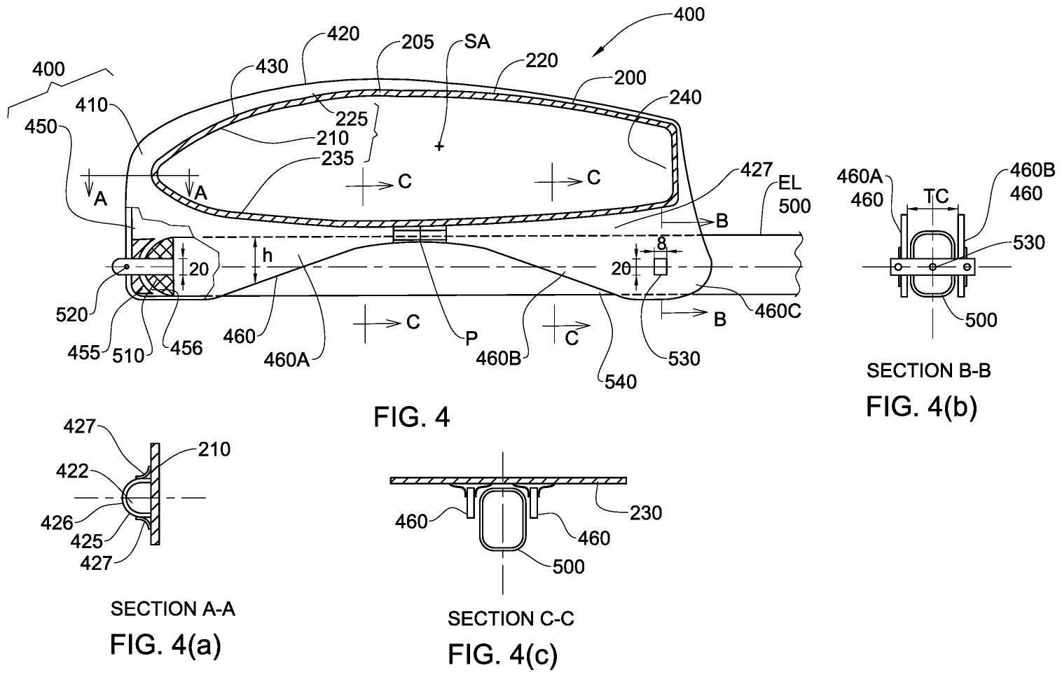

Referring to FIG. 4, 4(a), 4(b), 4(c) a composite structure according to a first example of a second aspect of the presently disclosed subject matter, generally designated 400, is in the form of a load-bearing composite structure, and is provided for use with an aerodynamic component 200.

In at least some examples, the load-bearing composite structure 400 can be considered as an external “rib” for the aerodynamic component, and further configured for enabling an external load EL to be supported on the wing via the load-bearing composite structure 400. Thus, the terms “external rib”, and “external rib structure” are used herein interchangeably with the load-bearing composite structure according to the second aspect of the presently disclosed subject matter.

As with the first aspect of the presently disclosed subject matter, mutatis mutandis, the aerodynamic component 200 is configured for aerodynamically interacting with an airflow and has an aerofoil-like cross section, and is at least a part of a subsonic or transonic wing 10, for generating aerodynamic lift for an aircraft, in which in at least some examples the wing can be connected to an aircraft fuselage. The wing has a span axis SA generally orthogonal to the aerofoil-like cross sections.

In this example, and as disclosed above, the aerodynamic component 200 has an external aerodynamic surface 205 including a leading edge 210 and a trailing edge, a suction surface 220 extending between the leading edge and the trailing edge, and a pressure surface 230 extending between the leading edge 210 and the trailing edge. The suction surface 220 is transversely spaced from the pressure surface 230 by the thickness of the aerofoil, which can vary along the chord of the aerofoil.

According to the second aspect of the presently disclosed subject matter, while the aerodynamic component is typically made from composite (and non-metallic) materials, the specific mechanical structure can be for example as disclosed above with reference to the first aspect of the presently disclosed subject matter, or, alternatively, the mechanical structure for the aerodynamic component can be different thereof, for example including conventional composite structure for the aerodynamic component, as are well known in the art.

According to the second aspect of the presently disclosed subject matter, the composite structure 400 is made from composite (i.e., non-metallic) materials and comprises a wing-coupling portion 410 configured for coupling to an aerodynamic component 200 in the form of a wing 10, and an external load coupling portion 450 configured for coupling to an external load EL.

The composite structure 400, in particular wing-coupling portion 410, is configured for being joined or otherwise connected to the external aerodynamic surface 205 of the wing 10 such as to be in overlying abutting and load bearing relationship with at least a contact surface portion CP of the external aerodynamic surface 205. Furthermore, the contact surface portion CP includes (referring to the transverse cross-section of the wing) the leading edge 210, at least a forward portion 225 of the suction surface 220 and at least a forward portion 235 of the pressure surface 230 of the external aerodynamic surface 205; furthermore, the load-bearing composite structure 400 is further configured for supporting at least one external load EL.

The load-bearing composite structure 400, in particular wing-coupling portion 410, in at least this example is in the form of a generally C-shaped body 420 (in side view) having a functional surface 430 conforming to the contact surface portion CP of the external aerodynamic surface 205.

In at least some examples, the load-bearing composite structure 400 is fixed to the wing 10 via connection of the functional surface 430 of the wing-coupling portion 410, with the contact surface portion CP of the external aerodynamic surface 205. Such connection can be integral, wherein the load-bearing structure 400 is manufactured together with the wing as a single integral unit, or, alternatively, the load-bearing composite structure 400 and the wing 10 are manufactured separately, and then the load-bearing composite structure 400 is affixed to the wing 10, for example co-bonded with carbon/epoxy fabric splice on the outer wing surface of the aerodynamic component 200.

In at least this example, and as best seen in FIG. 4(a), the load-bearing composite structure 400, in particular the C-shaped body 420 of wing-coupling portion 410, has a hollow structure, in which the outer skin 425 of C-shaped body 420 encloses a space 422. The outer skin 425 also has a U-shaped cross-section (in plan view) at least at or near the leading edge 210, having a base 426 of the “U” and arms 427 of the “U”.

In at least this example, the base 426 of the “U” is rounded or otherwise aerodynamically contoured, for example as a leading edge of an airfoil, to minimize drag.

In at least this example, the upper part of the C-shaped body 420 extends over the suction surface 220 aft as far as the contact portion CP, and over the pressure surface 230 up to the trailing end thereof. In particular, the arms 427 extend over the pressure surface 230 up to the trailing end thereof.

In at least this example, the external-load coupling portion 450 extends downwardly from the wing-coupling portion 410, and comprises a forward end 455 defining a concave recess 456, and side walls 460 extending aft, co-extensive with the arms 427.

The side walls 460 are spaced by spacing TC (FIG. 4(b)), and have a forward portion 460A, in which (for example to save weight) the height dimension h diminishes from a maximum height at recess 456, to a minimum at a point P, and an aft portion 460B, in which the height dimension increases from a minimum at a point P to a maximum height at or close to the aft end 460C of the walls 460.

In this example, the composite structure 400 is made from composite (i.e., non-metallic) materials. In particular, in this example the wing-coupling portion 410 is in the form of a structural fairing made of carbon/epoxy fabric layers for example up to 2 mm thickness, and having quasi isotropic properties.

Furthermore, in this example the external load coupling portion 450 is in the form of a structural fairing made of carbon/epoxy fabric layers for example up to 2 mm thickness, and having quasi isotropic properties

In this example, the external load EL is in the form of a boom 500 having a forward end 510 that is configured for being received in concave recess 456, and extends aft, enclosed laterally between the side walls 460, and further extending aft away from the side walls 460. In operation, the boom 500 carries loads from the empennage (not shown) to the wing in the form of aerodynamic component 200.

The boom 500 can be affixed or otherwise secured in load bearing relationship with respect to the composite structure 400, in particular with respect to the external load coupling portion 450, in any suitable manner, reversibly or non-reversibly. In this example, a first peg 520 is inserted into the end 510 via the forward end 455 and concave recess 456, providing a friction fit therebetween. A second peg 530 is inserted into an aft portion 540 of the boom 500 via the side walls 460, in particular the respective aft portions 460B thereof, providing a friction fit therebetween.

It is to be noted that the composite structure 400 is not part of the aerodynamic structure 200 per se, and thus the aerodynamic structure 200 for example in the form of a wing, is designed structurally to meet the loading requirements of thereof even in the absence of the composite structure 400. Furthermore, the composite structure 400 does not require conventional “hard points” on the wing, and thus does not require the wing to have internal spars or ribs. Thus, according to the second aspect of the presently disclosed subject matter the composite structure 400 can optionally be removed when there is no requirement for this, without adversely affecting the structural integrity of the aerodynamic structure 200 per se.

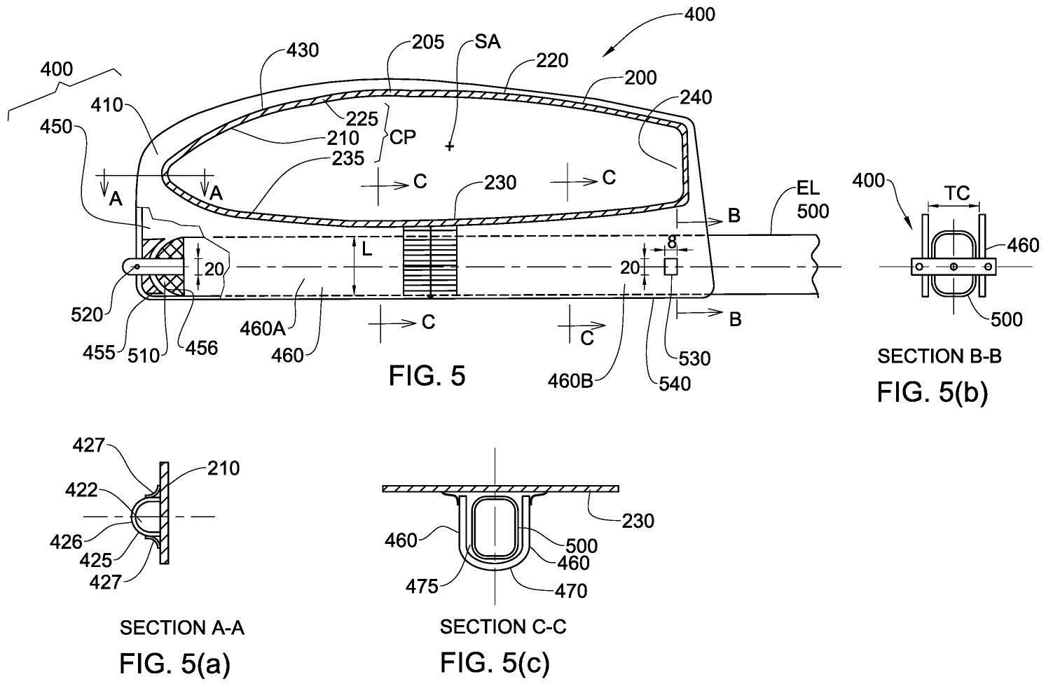

In an alternative variation of the example of FIGS. 4, 4(a), 4(b), and 4(c), and referring to FIGS. 5, 5(a), 5(b), 5(c), the aft walls 460 are formed with a uniform height, and further include a bottom wall 470 joined to the bottom edges of the side walls 460 for the first portion 460A of walls 460. This provides a U-shaped cross-section (in aft view, as best seen in FIG. 5(c)), defining a lumen 475 in which the boom 500 can be accommodated. In this example the boom 500 is also fixed or otherwise secured to the respective external load coupling portion 450 in a similar manner to the example of FIGS. 4 to 4(c), via a first peg 520 (inserted into the end 510 (via the forward end 455 and concave recess 456, providing a friction fit therebetween) and a second peg 530 inserted into an aft portion 540 of the boom 500 (via the side walls 460, in particular the respective aft portions thereof, providing a friction fit therebetween).

In the example of FIGS. 5, 5(a), 5(b), 5(c), the respective wing-coupling portion 410, is configured for being joined or otherwise connected to the external aerodynamic surface 205 of the wing 10 such as to be in overlying abutting and load bearing relationship, in which the respective contact surface portion CP of the external aerodynamic surface 205 circumscribes the periphery of the aerodynamic component 200. Thus in this example the contact surface portion CP includes (referring to the transverse cross-section of the wing) the leading edge 210, the full suction surface 220, the full pressure surface 230 and the trailing end 240 of the external aerodynamic surface 205.

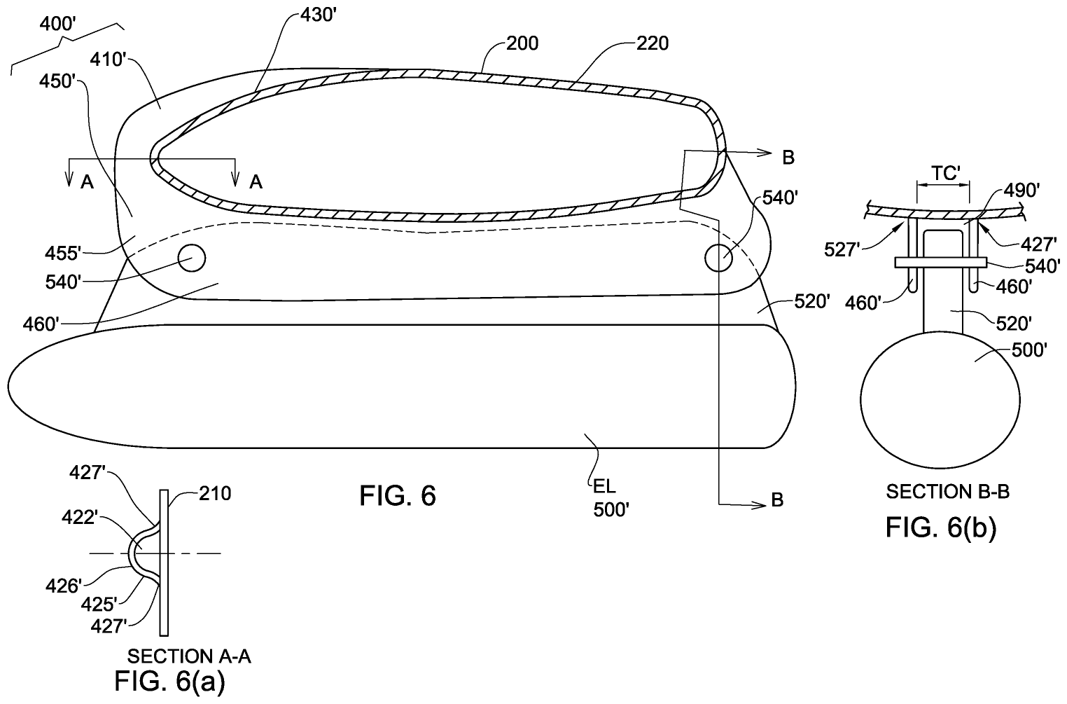

Referring to FIG. 6, 6(a), 6(b), a composite structure according to a second example of a second aspect of the presently disclosed subject matter, generally designated 400′, is also similar to the composite structure 400 according to the first example, mutatis mutandis, and is also in the form of a load-bearing composite structure, and is also provided for use with an aerodynamic component 200.

In at least some examples, the load-bearing composite structure 400′ can also be considered as an external “rib” for the aerodynamic component, and further configured for enabling an external load EL to be supported on the wing via the load-bearing composite structure 400.

The composite structure 400′, in particular wing-coupling portion 410′, is configured for being joined or otherwise connected to the external aerodynamic surface 205 of the wing 10 such as to be in overlying abutting and load bearing relationship with at least a contact surface portion CP of the external aerodynamic surface 205, in a similar manner to the first example, mutatis mutandis. Furthermore, the contact surface portion CP includes (referring to the transverse cross-section of the wing) the leading edge 210, at least a forward portion 225 of the suction surface 220 and at least a forward portion 235 of the pressure surface 230 of the external aerodynamic surface 205; furthermore, the load-bearing composite structure 400′ is further configured for supporting at least one external load EL.

The load-bearing composite structure 400, in particular wing-coupling portion 410′, in at least this example is in the form of a generally C-shaped body 420 (in side view) having a functional surface 430′ conforming to the contact surface portion CP of the external aerodynamic surface 205.

In at least some examples, the load-bearing composite structure 400′ is fixed to the wing 10 via connection of the functional surface 430′ of the wing-coupling portion 410′, with the contact surface portion CP of the external aerodynamic surface 205. Such connection can be integral, wherein the load-bearing structure 400′ is manufactured together with the wing as a single integral unit, or, alternatively, the load-bearing composite structure 400′ and the wing 10 are manufactured separately, and then the load-bearing composite structure 400′ is affixed to the wing 10, for example co-bonded with carbon/epoxy fabric splice on the outer wing surface of the aerodynamic component 200.

In at least this example, and as best seen in FIG. 6(a), the load-bearing composite structure 400′, in particular the C-shaped body 420′ of wing-coupling portion 410′, has a hollow structure, in which the outer skin 425′ of C-shaped body 420′ encloses a space 422′. The outer skin 425′ also has a U-shaped cross-section (in plan view) at least at or near the leading edge 210, having a base 426′ of the “U” and arms 427′ of the “U”.

In at least this example, the base 426′ of the “U” is rounded or otherwise aerodynamically contoured, for example as a leading edge of an airfoil, to minimize drag.

In at least this example, the upper part of the C-shaped body 420′ extends over the suction surface 220 aft as far as the contact portion CP, and over the pressure surface 230 up to the trailing end thereof. In particular, the arms 427′ extend over the pressure surface 230 up to the trailing end thereof.

In at least this example, the external-load coupling portion 450′ extends downwardly from the wing-coupling portion 410′, and comprises a forward end 455′, side walls 460′ extending aft, co-extensive with the arms 427′.

The side walls 460′ are spaced by spacing TC′ (FIG. 6(b)).

Also in this example, the composite structure 400′ is made from composite (i.e., non-metallic) materials. In particular, in this example the wing-coupling portion 410′ is in the form of a structural fairing made of carbon/epoxy fabric layers for example up to 2 mm thickness, and having quasi isotropic properties.

Furthermore, in this example the external load coupling portion 450′ is in the form of a structural fairing made of carbon/epoxy fabric layers for example up to 2 mm thickness, and having quasi isotropic properties

In this example, the external load EL is in the form of an external stores 500′ having a main stores body 510′, for example in the form of a pod, and that is configured for carrying some payload—for example an engine, a fuel tank, a camera, weapons, and so on. The external load EL also comprises a pylon structure 520′ that is configured for being received in the space 490′ enclosed laterally between the side walls 460′. In operation, the external stores 500′ can be ejected, or replaced,

The external stores 500′ can be affixed or otherwise secured in load bearing relationship with respect to the composite structure 400′, in particular with respect to the external load coupling portion 450′, in any suitable manner, reversibly or non-reversibly. In this example, pegs 540′ are each inserted into the pylon structure 520′ via the side walls 460′, providing a friction fit therebetween.

As with the first example, mutatis mutandis, it is also to be noted that the composite structure 400′ is not part of the aerodynamic structure 200 per se, and thus the aerodynamic structure 200 for example in the form of a wing, is designed structurally to meet the loading requirements of thereof even in the absence of the composite structure 400′. Furthermore, the composite structure 400′ does not require conventional “hard points” on the wing, and thus does not require the wing to have internal spars or ribs. Thus, according to the second aspect of the presently disclosed subject matter the composite structure 400′ can optionally be removed when there is no requirement for this, without adversely affecting the structural integrity of the aerodynamic structure 200 per se.

In the method claims that follow, alphanumeric characters and Roman numerals used to designate claim steps are provided for convenience only and do not imply any particular order of performing the steps.

Finally, it should be noted that the word “comprising” as used throughout the appended claims is to be interpreted to mean “including but not limited to”.

While there has been shown and disclosed examples in accordance with the presently disclosed subject matter, it will be appreciated that many changes may be made therein without departing from the scope of the presently disclosed subject matter as set out in the claims.

1. A composite structure for an aerodynamic component having an aerofoil-like cross-section and a leading edge, the composite structure being in the form of a torsion box arrangement having a core, the torsion box arrangement being made from composite materials, wherein the torsion box has a forward wall, an aft wall, a top wall and a bottom wall, together defining said core, and wherein said front wall is formed as the leading edge of the aerodynamic component.

2. The composite structure according to claim 1, wherein said top wall is formed with an external first surface corresponding to a suction surface of the aerodynamic component, and wherein said bottom wall is formed with an external second surface corresponding to a pressure surface of the aerodynamic component.

3. The composite structure according to claim 2, wherein:
said forward wall is longitudinally spaced from said aft wall by a longitudinal spacing;
said upper wall is transversely spaced from said bottom wall by a transverse spacing;
the forward wall is connected to a respective first edge of each one of said top wall and said bottom wall;
the aft wall is connected to a respective second edge of each one of said top wall and said bottom wall;
said forward wall and said aft wall have a transverse dimension whereby to provide said transverse spacing;
said top wall and said bottom wall have a longitudinal dimension whereby to provide said longitudinal spacing.

4. The composite structure according to any one of claims 1 to 3, wherein said forward wall comprises an externally facing aerodynamic leading edge surface and an internally facing leading end inner surface.

5. The composite structure according to any one of claims 1 to 4, wherein:
said top wall comprises an externally facing first aerodynamic surface and an internally facing first inner surface;
said bottom wall comprises an externally facing second aerodynamic surface and an internally facing second inner surface;

6. The composite structure according to any one of claims 1 to 5, wherein said aft wall is configured structurally as a trailing end spar and includes an externally facing trailing end surface and an internally facing leading end inner surface.

7. The composite structure according to claim 6, wherein:
said forward wall, said aft wall, said top wall, and said bottom wall are made from composite materials; and
wherein said internally facing leading end inner surface, said internally facing first inner surface, said internally facing second inner surface, and said internally facing leading end inner surface enclose said core.

8. The composite structure according to any one of claims 1 to 7, wherein said torsion box arrangement extends laterally between a first torsion box end and a second torsion box end.

9. The composite structure according to claim 8, wherein said torsion box arrangement has a lateral dimension between a first torsion box end and a second torsion box end.

10. The composite structure according to any one of claims 1 to 9, wherein said torsion box arrangement has an absence of any structural member, different from said aft wall, transversely spanning said hollow core between said top wall and said bottom wall.

11. The composite structure according to any one of claims 1 to 10, wherein said core is spar-less.

12. The composite structure according to any one of claims 1 to 11, wherein said torsion box arrangement has an absence of any structural member, different from said aft wall, accommodated in said core and extending in a spanwise direction.

13. The composite structure according to any one of claims 1 to 12, wherein the torsion box arrangement, has an absence of a main spar, or of a web of such a main spar, at the respective conventional location of such a main spar in conventional wings.

14. The composite structure according to any one of claims 1 to 13, wherein the torsion box arrangement, has an absence of a main spar, or of a web of such a main spar, at least between the aerofoil leading edge and 60% of a chord of the aerofoil, or at least between the aerofoil leading edge and 50% of the chord of the aerofoil, or at least between the aerofoil leading edge and 40% of the chord of the aerofoil, or at least between the aerofoil leading edge and 30% of the chord of the aerofoil, or at least between 20% and 30% of the chord of the aerofoil aft of the aerofoil leading edge.

15. The composite structure according to any one of claims 1 to 14, wherein said core is rib-less.

16. The composite structure according to any one of claims 1 to 15, wherein said torsion box arrangement has an absence of any rib structural member, accommodated in said core between said top wall and said bottom wall.

17. The composite structure according to any one of claims 1 to 16, wherein said top wall and said bottom wall each extends aft in a chordwise direction at least past a chordwise location of the neutral point NP of the aerofoil.

18. The composite structure according to any one of claims 1 to 17, wherein said top wall and said bottom wall each extends aft in a chordwise direction at least past between 20% and 30% of a chord of the aerofoil.

19. The composite structure according to claim 18, wherein said top wall and said bottom wall each extends aft in a chordwise direction more than 40%, or more than 50% or more than 60% or more than 70% of the chord.

20. The composite structure according to any one of claims 1 to 19, wherein said forward wall is configured structurally as a leading end spar.

21. The composite structure according to any one of claims 1 to 20, wherein said forward wall, said aft wall, said top wall, and said bottom wall are made exclusively from a first composite material.

22. The composite structure according to any one of claims 1 to 20, wherein said forward wall, said aft wall, said top wall, and said bottom wall are made from a first composite material comprising multiple layers of composite fibers embedded in a matrix, and further comprising a second composite material comprising a stiffening structure.

23. The composite structure according to any one of claims 1 to 22, wherein said forward wall, said aft wall, said top wall, and said bottom wall have an absence of metallic materials.

24. The composite structure according to any one of claims 1 to 23, wherein said torsion box arrangement has a closed transverse section.

25. The composite structure according to any one of claims 1 to 24, wherein said core is a hollow core.

26. The composite structure according to any one of claims 1 to 24, wherein said core is at least partially fillable with a liquid material.

27. The composite structure according to any one of claims 1 to 26, wherein said top wall comprises at least one first stiffening member co-extensive therewith and joined thereto.

28. The composite structure according to claim 27, wherein said at least one first stiffening member is made from third composite materials comprising a unidirectional fiber structure embedded in a matrix.

29. The composite structure according to any one of claims 1 to 28, wherein said bottom wall comprises at least one second stiffening member co-extensive therewith and joined thereto.

30. The composite structure according to claim 29, wherein said at least one second stiffening member is made from fourth composite materials comprising a unidirectional fiber structure embedded in a matrix.

31. The composite structure according to any one of claims 5 to 30, wherein said externally facing aerodynamic leading edge surface, said first externally facing first aerodynamic surface, said externally facing second aerodynamic surface and said externally facing trailing end surface define an outer mold line.

32. The composite structure according to any one of claims 1 to 31, wherein said internally facing leading end inner surface, said internally facing first inner surface, said internally facing second inner surface, and said internally facing leading end inner surface define an inner mold line.

33. The composite structure according to any one of claims 1 to 32, wherein the aerodynamic component is a wing, and wherein said forward wall is configured aerodynamically as a leading edge of the wing

34. The composite structure according to any one of claims 1 to 32, wherein the aerodynamic component is any one of: a vertical stabilizer, horizontal stabilizer, vane, canard, rudder, other aerodynamic control surfaces.

35. The composite structure according to any one of claims 1 to 34, further comprising a load-bearing composite structure for use with the aerodynamic component, the aerodynamic component having an external aerodynamic surface including said leading edge and a trailing edge, said suction surface extending between the leading edge and the trailing edge, and said pressure surface extending between the leading edge and the trailing edge, the load bearing composite structure being made from composite materials and configured for being joined to the external aerodynamic surface such as to be in overlying abutting relationship with at least a contact surface portion of the external aerodynamic surface, the contact surface portion including the leading edge, at least a forward portion of the suction surface and at least a forward portion of the pressure surface of the external aerodynamic surface, the load-bearing composite structure being further configured for supporting at least one external load.

36. The composite structure according to claim 35, wherein the load-bearing composite structure comprises a wing-coupling portion configured for coupling to the aerodynamic component, and an external load coupling portion configured for coupling to said at least one external load.

37. The composite structure according to claim 36, wherein said wing-coupling portion is configured for being joined or otherwise connected to the external aerodynamic surface such as to be in overlying abutting and load bearing relationship with at least said contact surface portion.

38. The composite structure according to claim 36 or claim 37, wherein said wing-coupling portion comprises a functional surface conforming to the contact surface portion of the external aerodynamic surface.

39. The composite structure according to any one of claims 36 to 38, wherein said external load coupling portion comprises a pair of spaced lateral walls for holding therein at least a part of said at least one external load, and further comprising at least one peg configured for concurrently traversing said pair of spaced lateral walls and said part of said at least one external load.

40. The composite structure according to any one of claims 35 to 39, wherein said external load is in the form of any one of:
a boom connected to an empennage;
an external store having a pylon structure;
an external store having a pylon structure, wherein said external stores includes any one of: engine, a fuel tank, a camera, weapons.

41. A load-bearing composite structure for use with an aerodynamic component, the aerodynamic component having an external aerodynamic surface including a leading edge and a trailing edge, a suction surface extending between the leading edge and the trailing edge, and a pressure surface extending between the leading edge and the trailing edge, the composite structure being made from composite materials and configured for being joined to the external aerodynamic surface such as to be in overlying abutting relationship with at least a contact surface portion of the external aerodynamic surface, the contact surface portion including the leading edge, at least a forward portion of the suction surface and at least a forward portion of the pressure surface of the external aerodynamic surface, the load-bearing composite structure being further configured for supporting at least one external load.

42. The load-bearing composite structure according to claim 41, comprising a wing-coupling portion configured for coupling to the aerodynamic component, and an external load coupling portion configured for coupling to said at least one external load.

43. The load-bearing composite structure according to claim 42, wherein said wing-coupling portion is configured for being joined or otherwise connected to the external aerodynamic surface such as to be in overlying abutting and load bearing relationship with at least said contact surface portion.

44. The load-bearing composite structure according to claim 42 or claim 43, wherein said wing-coupling portion comprises a functional surface conforming to the contact surface portion of the external aerodynamic surface.

45. The load-bearing composite structure according to any one of claims 42 to 44, wherein said external load coupling portion comprises a pair of spaced lateral walls for holding therein at least a part of said at least one external load.

46. The load-bearing composite structure according to claim 45, comprising at least one peg configured for concurrently traversing said pair of spaced lateral walls and said part of said at least one external load.

47. The load-bearing composite structure according to any one of claims 41 to 46 wherein said external load is in the form of a boom connected to an empennage.

48. The load-bearing composite structure according to any one of claims 41 to 46 wherein said external load is in the form of an external store having a pylon structure.

49. The load-bearing composite structure according to claim 48, wherein said external stores includes any one of: engine, a fuel tank, a camera, weapons.

50. The composite structure according to any one of claims 41 to 49, wherein the aerodynamic component is a wing.
